(19) United States
(12) Patent Application Publication
(10) Pub. No.: US 2009/0052703 A1
(43) Pub. Date: Feb. 26, 2009

(54) System and Method Tracking the Position of a Listener and Transmitting Binaural Audio Data to the Listener

(75) Inventor: Dorte Hammershoi, Aalborg (DK)

Correspondence Address: FOLEY AND LARDNER LLP;SUITE 500, 3000 K STREET NW, WASHINGTON, DC, 20007, US

(73) Assignee: AALBORG UNIVERSITET, Aalborg O (DK)

(21) Appl. No.: 12/295,979

(22) PCT Filed: Apr. 4, 2007
(86) PCT No.: PCT/DK2007/000174

§ 371 Date: Nov. 13, 2008

(30) Foreign Application Priority Data
Apr. 4, 2006 (DK) PA 2006 00481

(51) Int. Cl. H04R 5/02; H04R 5/00

(52) U.S. Cl. 381/310; 381/1

(57) ABSTRACT

A binaural technology method includes: determining positions related to position of both ears of a listener, receiving a wireless RF signal including binaural audio data is received, and presenting the binaural audio data to the listener By determining ear positions of a listener e.g. in 3D, information of the listener's position e.g. in a virtual environment is known, and further by wireless transmitting binaural audio signals to the listener, it becomes possible to transmit 3D audio data matching the listener's position and movements accordingly. Further, since the position of both ears is known, it is possible to individually match the binaural audio data to the listener, since it is possible to derive from the ear positions a distance between the listener's ears, and hereby a valuable parameter is known that can be used to generate binaural signals that individually fits the listener. Thus, the listener can be provided with a better 3D audio experience. Especially, the determined positions may correspond to ear canal reference points for the binaural audio data. The positions in the ears may be derived based on RF signals, e.g. by using earphones, e.g. in-the-ear type earphones, that are also used to wirelessly receive and reproduce the binaural audio data to the listener. The ear phones may be arranged to wirelessly transmit the determined position data to a remote processor that generates the binaural audio data accordingly. The method may be used for applications such as: binaural synthesis, binaural capturing, inverse binaural filtering, Virtual Reality, Mixed Reality, teleconferencing, inter-com, exhibition/museum, and traffic signals.

### FIELD OF THE INVENTION

The invention relates to the field of electro-acoustics, more specifically to the field of binaural technology. The invention provides a binaural technology method and a binaural technology system capable of tracking a position of a listener and generate binaural signals in response thereto. Thus, the method and system is applicable e.g. for binaural synthesis applications such as Virtual Reality scenario.

### BACKGROUND OF THE INVENTION

The idea behind binaural technology is that control of sound pressures at a listening person's ear drums provides control of the person's auditory impression. Thus, by generating proper signals at the person's ear drums, e.g. by means of headphones, it is possible to generate an artificial auditory environment with virtual sound sources and virtual reflecting surfaces etc. This is known as binaural synthesis and can be used e.g. within Virtual Reality (VR) applications where binaural signals are created that virtual sound sources. In many of such applications, it is desired that the listener can move around, and in order to provide the listener with a correct auditory impression, the binaural synthesis system must be able to on-line track the listener's position, and also an orientation of the listener's head, and generate binaural signals in accordance with this position and head orientation (i.e. both head azimuth and head tilt). For example, in order for a stationary virtual sound source to keep its position in a virtual auditory environment when the listener moves, then selection of proper Head-Related Transfer Functions (HRTFs) and calculation of a distance from the person to the virtual sound source is required. Thus, for many dynamic applications of binaural technology tracking of a listener's position in space and possibly head orientation is crucial for a successful result.

U.S. Pat. No. 6,961,439 B2 shows an example of a system for producing virtual sound sources at a given position relative to a listener, by providing a set of binaural signals to a listener with HRTFs corresponding to the relative position of the virtual sound source. A head tracking system determines the location and orientation of the listener's head. This location and orientation information is processed in a computer system that selects HRTFs accordingly and thus produces binaural signals taking into account location and orientation of the listener.

3D head tracking devices for VR applications exist, e.g. wireless types from the company Polhemus. Such devices are often based on a tracking device fixed to the person's head with three coils perpendicular to each other. If the person moves within the boundary of a static magnetic field, then the three coils are then used to sense the magnetic field, and based thereon, it is possible to decode position and orientation of the tracking device and thus the person. A signal representing the position and orientation can then be wirelessly transmitted from the tracking device to a stationary signal processing unit that updates its binaural synthesis according thereto.

### SUMMARY OF THE INVENTION

While existing head tracking methods can provide sufficient position information to select an HRTF in a database for binaural synthesis applications, such methods are insufficient for providing position information that allow a higher degree of listener individual adaptation of HRTFs for the binaural synthesis. In addition, existing methods provide insufficient position information to allow decomposition of an auditory real-life scenario.

Thus, it may be seen as an object of the present invention to provide a method and a system for solving the mentioned problems.

In a first aspect, the invention provides a binaural technology method including
determining a first position related to a position of left ear of a listener,
determining a second position related to a position of right ear of the listener,
receiving a wireless RF signal including binaural audio data, and
presenting the binaural audio data to the listener.

By determining positions, preferably 3D positions, of both ears of a listener, it is possible to directly extract an actual Interaural Time Difference (ITD) of the individual listener since a distance between his/her ears is known due to the known positions of both ears. Thus, with a known ITD for the listener, it is possible to adapt the binaural audio data presented to the listener to individual characteristics of the listener and thereby improve auditory localization performance in binaural synthesis applications. In binaural capturing applications the individual ITDs can be used for signal processing enabling decomposition of an auditory real-life scenario.

Preferably, the first and second positions correspond to ear canal reference points for the binaural audio data, since it is then directly possible to derive ITD relevant for actual binaural signals recorded in the ears of the listener, and there is a one-to-one relation between the determined positions and the binaural audio data. Preferably, the ear canal reference points are entrances to blocked ear canals of the listener, since these reference points have a number of advantages, e.g. a minimum of inter-individual differences.

In preferred embodiments, the method further includes determining the binaural audio data based on the sensed first and second positions prior to transmitting the wireless RF signal including the binaural audio data, and thus the determined positions are advantageously used for preparing the binaural audio data. This may include e.g. selecting HRTFs in a binaural synthesis system in response to the determined first and second positions.

In preferred embodiments, the first and second positions are extracted from a second wireless RF signal. With a separate RF signal dedicated to the position determination, there is no need for the listener to be connected to further equipment by wire.

This may be implemented by either including in the second wireless RF signal data indicating at least one of the first and second positions, such as indicating both of the first and second positions. Preferably, the first and second positions are sensed in respective ears of the listener, and data regarding the first and second positions are included in the second wireless RF signal. Thus, according to these embodiments the actual position determination is performed by equipment on or close to the listener, and then only data representing the position results are transmitted in a wireless RF signal.

Alternatively, at least one of the first and second positions is extracted based on detecting a location from which the second wireless RF signal is transmitted. Thus, according to this embodiment, the actual position determination may be but is not necessarily performed by equipment close to the listener. E.g. it is only required that RF transmitters are positioned close to the listener's body, such as close to the ear positions, preferably the second wireless RF signal is transmitted from one of the first and second positions, e.g. built into audio inserts in the ear canals of the listener. The position determining equipment capable of receiving the second wireless RF signal can then be stationary equipment remotely located to the listener. In preferred embodiments, the first position is extracted based on the second wireless RF signal and wherein the second position is extracted based on a third wireless RF signal. Thus, by using separate wireless RF signals for each of the two positions, it is possible that the two RF transmitters are independent of each other, thus they do not need to be interconnected. The first and second positions are then extracted based on detecting locations from which the second and third wireless RF signals are transmitted. Preferably, the second and third wireless RF signals are transmitted from separate first and second locations close to the listener's body, such as from respective locations in left and right ears of the listener.

The method may include the steps of recording binaural audio data in left and right ears of the listener, i.e. binaural capturing. These recorded binaural data may be presented to the listener substantially simultaneous with the recording, thus allowing the listener to have a more or less normal hearing thus still being aware of the actual auditory environments. In preferred embodiments including binaural recording also include the steps of presenting the recorded binaural signals to the listener, more preferably these embodiments may include binaural synthesis and thus provide the listener with a Mixed Reality, i.e. a combination of synthesized sound sources and real-life listening.

Preferably, the method includes deriving a measure of interaural time delay (ITD) based on the first and second positions. Since the two ear positions are determined, it is possible from a known simple relation to determine a measure of ITD for the listener, i.e. also a measure of a size of the head of the listener.

The method may also include estimating an orientation of the ears of the listener at least partly based on the determined first and second positions. Since the first and second positions are known, preferably as coordinates in a predetermined coordinate system, it is easy to calculate an orientation of the ears or head of the listener based thereof. At least if the listener looks straight ahead or turns his head in the saggital plane the head orientation can be tracked by the two positions. However, an ambiguity occurs if the listener turns his head in the vertical plane, e.g. by looking downwards or upwards, since a head turn in the vertical plane changes head orientation but not ear positions. In many applications with sound sources predominantly in the horizontal plane, this will not be any problem. However, for sound sources out of the horizontal plane it may be preferred to add a simple sensor in one ear of the listener that senses a turn of the head in the vertical plane, e.g. relative to the gravity.

At least the first position is preferably determined at an update rate that is suitable for an adequate tracking of movement that capable of producing an acceptable relation between movement and auditory impression of the listener in case of a binaural synthesis system, i.e. without disturbing delay and at an update that does not suffer from severe drop outs that may cause in a binaural synthesis system a sound source intended to be stationary to move. Preferably, the update rate is more than 50 Hz, such as more than 60 Hz, more preferably more than 80 Hz, and most preferably more than 100 Hz.

In a second aspect, the invention provides a binaural technology system comprising
position tracking means arranged to determine first and second positions related to positions of respective left and right ears of a listener,
an RF receiver arranged to receive a wireless RF signal including binaural audio data, and
a set of earphones arranged to generate sound pressures in the ears of the listener, the sound pressures representing the binaural audio data.

The same advantages as explained for the first aspect also apply for the second aspects, and it is appreciated that embodiments of the first and second embodiments can be combined.

The first and second positions preferably correspond to ear canal reference points for the binaural data.

Preferably, the position tracking means includes an RF transmitter arranged to transmit a second wireless RF signal allowing determination of the first and second positions.

The position tracking means may include position sensing means arranged to sense the first position, and wherein the RF transmitter is arranged to include data indicating the first position in the second wireless RF signal. The position tracking means may further include a second sensing means arranged to senses the second position, and wherein the RF transmitter is arranged to further include data indicating the second position in the second wireless RF signal.

The RF transmitter may be arranged for location at the first position, and wherein the position tracking means further includes a second RF receiver arranged to receive the second wireless RF signal and determine the first position by detecting a location from which the second wireless RF signal is transmitted. A second RF transmitter may be arranged for transmitting a third wireless RF signal, the second RF transmitter being arranged for location at the second position, and wherein the second RF receiver is further arranged to receive the third wireless RF signal and determine the second position by detecting a location from which the third wireless RF signal is transmitted. The second RF receiver may include an array of antennas and a signal processing unit.

The RF transmitter may be positioned in connection with the earphone, and/or the RF transmitter is arranged for position in an ear canal of the listener.

Preferably, the earphone includes first and second separate earphone parts arranged for position in respective ears of the listener. The first and second earphone parts may be wirelessly interconnected so as to allow wireless transfer of audio data between the first and second earphone parts. The RF transmitter may be included in one of the first and second earphone parts. The RF transmitter may be included in the first earphone part, and wherein a second RF transmitter arranged to transmit a third wireless RF signal, is included in the second earphone part.

The system may further include first and second microphones arranged for position at ear canal reference points for the binaural audio data. The first and second microphones are preferably arranged for position at entrances to the respective ears of the listener. The first and second microphones are preferably included in respective first and second earphone parts arranged for position in respective ears of the listener.

Each of the first and second earphone parts may include respective RF transmitters arranged to transmit respective wireless RF signals. The first and second earphone parts are in-the-ear type earphones. The RF receiver may be included in one of the first and second earphone parts.

In further aspects, the invention provides use of the method according to the first aspect for one or more of: a binaural synthesis application, a binaural capturing application, an inverse binaural filtering application, a Virtual Reality application, a Mixed Reality application (i.e. combination of synthesized sound sources and real-life listening) a teleconferencing application, an inter-com application, an exhibition/museum application, and a traffic signaling application.

It is appreciated that the method and system according to the invention is applicable within a larger number of implementation of binaural technology where a dynamic position tracking of the listener is required or advantageous.

### BRIEF DESCRIPTION OF THE DRAWINGS

In the following the invention is described in more details with reference to the accompanying figures, of which

FIG. 1 illustrates a sketch of one embodiment according to the invention,

FIG. 2 illustrates a sketch of another embodiment,

FIG. 3 illustrates a preferred system according to the invention, and

FIG. 4 illustrates a preferred wireless audio insert for use e.g. in the system of FIG. 3.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION OF PREFERRED EMBODIMENTS

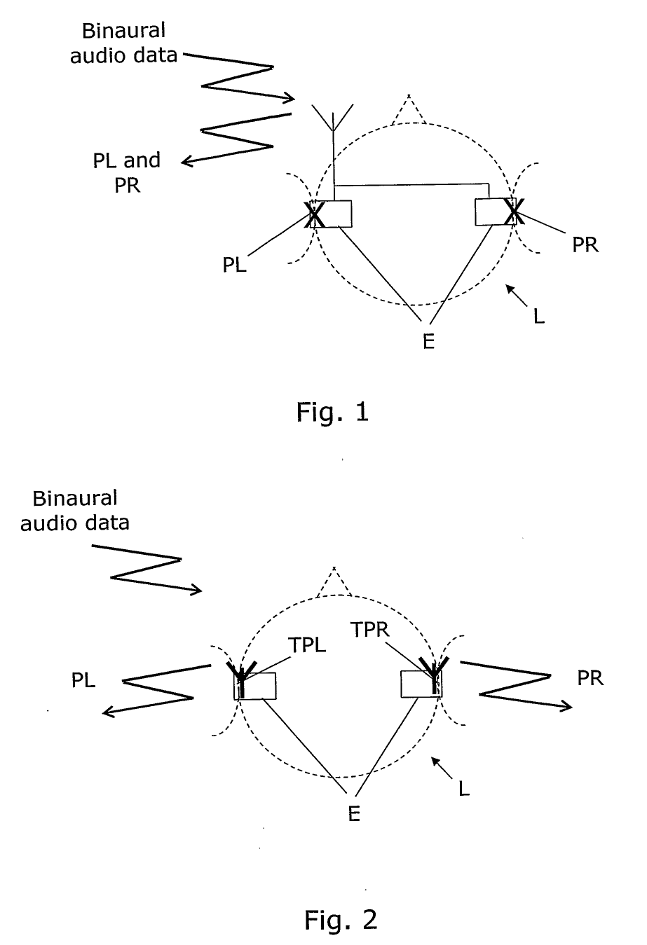

FIG. 1 illustrates, with dashed curve, a head and ears of a listener L seen from above. Points PL and PR indicate reference points for binaural audio data in respective left and right ear of the listener. Preferably, the reference point is selected to be at an entrance to the blocked ear canal, since this reference point has proven to be less influenced by inter-individual differences, however other reference points can be used as well—either in the ear canal or outside the ear canal. Earphones E, formed as audio inserts, are inserted in the ear canals of the listener with transducers arranged to present binaural audio data that are transmitted in a wireless RF signal. The audio inserts are preferably in-the-ear type inserts, such as complete-in-the-canal type inserts.

In FIG. 1 the RF receiver is sketched as a single antenna that receives both left and right ear audio data which are then received in a receiver circuit that slits the signal into respective left and right ear signals. In the embodiment of FIG. 1, position sensors are positioned in the earphones that are formed as separate left and right audio inserts. Thus, a 3D position, i.e. a location in space, for each of PL and PR can be determined, hereby determining positions in space of both ears of the listener L. The position sensors can be based on coils sensing a stationary magnetic field or by other means. The determined 3D coordinates for PL and PR are then transmitted in a wireless RF signal. This signal can then be received by a remotely located binaural audio processing system that adapts its binaural processing according to the received 3D coordinates for left and right ears.

The RF transceiver for receiving audio data and transmitting left and right ear position data may be built into one the audio inserts for one ear while audio data and position of the opposite ear are transferred to the audio insert with a wired connection or by means of another type of wireless interconnection. Alternatively, both left and right audio inserts have built-in RF transceivers, or more alternatively, the two audio inserts are connected by wire or wirelessly to a separate RF transceiver unit that can be carried by the listener, such as in a pocket of the listener.

More alternatively, the earphones may be of the behind-the-ear type earphones, such as known from hearing aids. Thus, only a transducer part of the earphone is inserted in the ear canal of the listener, while electronic circuits, including an RF transmitter and RF receiver, and the position sensor is built into the behind-the-ear part.

Alternatively, the earphones may also be formed as a traditional stereo headphone, where position sensors are placed close to the ears of the listener.

The type of RF signal used to transmit audio data and position data can be different, taking into account that high quality audio data requires a larger data rate than the position coordinates. Alternatively, both audio data and position data are included in the same RF signal.

FIG. 2 illustrates a sketch of an alternative embodiment to the one illustrated in FIG. 1. In the embodiment of FIG. 2 positions in space of the points PL and PR are determined based on wireless RF signals transmitted from the points themselves. FIG. 2 illustrates audio inserts in the ear canals of the listener L. Separate wireless RF transmitters TPL, TPR for left and right ears are built into or at least integrated with the respective left and right audio inserts. The wireless RF transmitters TPL, TPR are arranged such that the wireless RF signals are transmitted from points PL and PR, respectively. Thus, spatially separate wireless RF signals are transmitted from locations related to each ear of the listener.

In contrast to the embodiment of FIG. 1, the wireless RF signals PL and PR of FIG. 2 do not in themselves carry data representing the left and right 3D position, but the left and right 3D position data are extracted based on detecting the location of the wireless RF transmitter, such as known in the art of locating wireless RF signals. It is appreciated that the type of wireless RF signal used and the method of extracting the 3D position data should be selected such that both spatial and temporal resolution of the 3D position data is sufficient to track position of the ears of the listener moving at a desired maximum speed. Preferably, the spatial resolution should be such that it is possible to derive an ITD with an acceptable precision, i.e. the spatial resolution is preferably better than 1 cm, more preferably better than 5 mm, more preferably better than 2 mm.

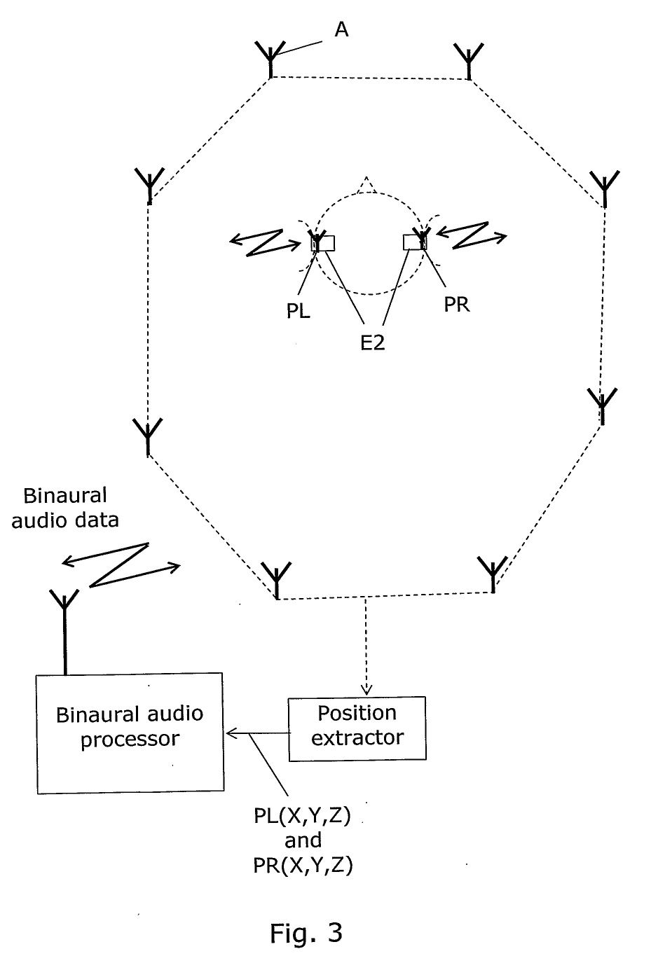

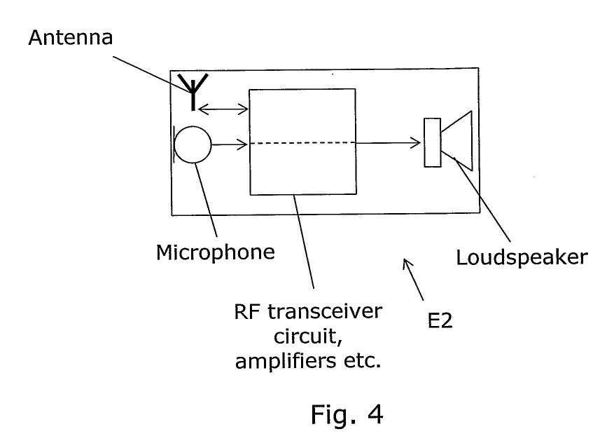

FIG. 3 illustrates a binaural system, e.g. for VR applications. A listener wears earphones E2, preferably based on wireless audio inserts that are illustrated in more details in FIG. 4. Wireless RF transmitters located in each of the audio inserts transmit wireless RF signals that are received by an array of antennas A with the purpose of determining the position of the RF transmitters and thus the ears of the listener. The antenna array in FIG. 3 is for clarity reasons illustrated as a 2D array, but preferably the antenna array is a 3D array arranged to cover a target zone in 3D so as to be able to track 3D position of the listener's ears within the target zone. The straight dashed lines serve to illustrate that the single antennas A of the array are connected to a position extractor that process the wireless RF signal received on the single antennas and extracts a position in space, i.e. X, Y and Z coordinates, of each of the points PL and PR. By prior knowledge of the RF signal transmitted from the audio insert, knowledge of the antenna array etc., it is possible to derive or extract 3D positions PL(X,Y,Z), PR(X,Y,Z) of both points PL, PR. This extraction method can e.g. include applying a correlation algorithm to the signals received at the antennas A in order to derive phase difference or arrival time differences, combined with knowledge about the physical location of the antennas A.

The type of antennas A, their number and their configuration sketched in FIG. 3 merely serve to illustrate the principle. The actual choice should be made in connection with the selected type of wireless RF signal, the desired spatial and temporal resolution and the size of the 3D target zone.

As sketched in FIG. 3 the determined 3D positions PL(X,Y,Z), PR(X,Y,Z) are applied to a binaural audio processor. In case of a VR application, the binaural audio processor may perform binaural synthesis by convolved an audio signal with HRTFs or selected based on the 3D positions PL(X,Y,Z), PR(X,Y,Z), and the resulting binaural audio data are wirelessly transferred to the audio inserts that presents corresponding binaural signals to the listener.

Since the position tracking of both ears allow an estimate of an actual ITD for the listener, it is possible to adapt HRTFs, e.g. parameterized HRTFs, stored in a data bank in order to make the HRTFs better fit the individual listener. A simple implementation could be to have e.g. three sets of HRTFs stored: one to fit large head sized, one for medium head sizes and one for small head sizes. Hereby a better binaural synthesis with improved localization performance may be obtained compared to a situation where one set of standardized HRTFs is used for all listeners.

The update rate of the 3D positions PL(X,Y,Z), PR(X,Y,Z) should be fast enough to track expected movements of the listener, e.g. rapid head turns, in order for the binaural audio processor to be able to react accordingly. For example such that a static artificial sound source is perceived by the listener to remain in the same position without being affected by his/her head movements.

FIG. 4 shows a rough sketch of a preferred wireless audio insert E2 adapted for insertion in the ear canal of the listener, preferably such that an acoustic opening in connection with the microphone in positioned at or close to an entrance to the ear canal of the listener. The microphone then picks up sound pressure at the ear of the listener and produces an electric signal representative thereof. A loudspeaker is positioned such that it is capable of producing a sound pressure from an opening close to the ear drum of the listener. An antenna forms part of an RF transmitter capable of transmitting a wireless RF signal to be used for location purpose as described in connection with FIG. 3. Thus, the position of the antenna will determine the actual position determined. Preferably, the antenna is positioned such in the audio insert E2 that it is at or at least near an entrance to the ear canal of the listener, when the insert E2 is properly positioned in the ear canal, thus the wireless RF signal used for location purpose will be close to a preferred reference point for binaural technique, namely entrance to blocked ear canal, the same point where the microphone is capable of picking up sound pressure.

The box that interconnects antenna, microphone and loudspeaker indicates all necessary electronic signal processing including RF transmitter circuits, audio amplifiers etc. As indicated by the double arrow connecting the antenna, data representing sound pressure picked up by the microphone can be transmitted in a wireless RF signal from the antenna.

Even though the audio insert at least to some degree blocks the listener's ears for sound from the environments, it is preferred for some applications (especially combinations of binaural synthesis and real life listening) that the sound pressures picked up by the microphones are reproduced by the loudspeaker or receiver transducer of the inserts such that the listener has a transparent, undisturbed impression of the auditory environments. This transparent or by-pass situation is illustrated by the dashed line connecting microphone and loudspeaker.

In FIG. 3, the double-arrow indicating an optional wireless two-way binaural audio data transfer which is relevant in connection with audio inserts E2, such as described in connection with FIG. 4. On-line binaural sound pressures in the ears of the listener can be wirelessly transferred together with the corresponding on-line 3D positions PL(X,Y,Z), PR(X,Y,Z). Such recorded binaural signals can preferably be wirelessly transmitted to the binaural audio processor, either for storing purpose or for the purpose of further signal processing.

The mentioned further signal processing may include processing with the purpose of decomposition of the auditory scenario surrounding the listener, e.g. using inverse binaural filtering or inverse binaural cocktail-party processing, i.e. signal processing performed on the binaural signals with the purpose of identifying and/or focusing one or more specific sound sources among other, e.g. by extracting from the recorded binaural signal one speaking voice among other, and amplifying the one voice with the purpose of increasing the listener's speech intelligibility of the one voice. Such processing is possible based on binaural signals recorded in a dynamic situation, i.e. with listener movements and possibly also sound source movements, together with tracking of position of the listener's ears.

Applications such as decomposition of an auditory scenario is advantageous with the position tracking according to the invention, since an actual ITD of the listener can estimated based on the 3D positions PL(X,Y,Z), PR(X,Y,Z), whereas in prior art head tracking systems only a mid point of the listener's head and its orientation is known, i.e. no ITD can be derived.

The mentioned further signal processing may include mixing virtual sound sources with the real auditory event picked up by the microphones in the audio inserts E2. E.g. when the listener walks around in a real life environment, it is possible to have a transparent auditory impression of the environment using the microphones that bypasses sound to the loudspeakers. Since the position of the listener's ears is known, it is possible to synthesize a virtual sound at a desired location relative to the listener. Such virtual sound may be used to make the listener part of a teleconference still walking around in a workplace. One distinct location in space relative to the listener can be used for each person participating in the teleconference, thus improving speech intelligibility even if the listener is still capable of noticing calls or warning signal in the workplace environment.

In another application, the location tracking is used to provide a virtual sound being a narrator voice explaining about an object at an exhibition, for example a piece of art at a museum, as the listener approaches the object. Due to the ear position tracking, it is possible to provide an impression that the narrator is positioned close to the piece of art irrespective of the listener's position and head orientation. As the listener approaches another piece of art, the position tracking is used to switch to another narrator explaining about the other piece of art.

In yet another application, the location tracking is used to provide a listener moving around in the traffic with position related information, such as traffic signals. For example the listener listens to MP3 music files via earphones, and approaching a stop signal, the listener is warned in the earphones, e.g. by turning down volume of the music and/or playing a warning signal at a perceived auditory direction corresponding to the actual location of the stop signal. Thus, a virtual sound source is used to focus the listener towards the stop signal.

Referring to FIG. 3 the position extractor and binaural audio processor may be implemented as stationary equipment, e.g. with the binaural audio processor implemented as a software algorithm executed on a computer such as a Personal Computer. Alternatively, one or both of the position extractor and binaural audio processor may be manufactured as compact equipment that can be carried by the listener, e.g. in a pocket.

1-48. (canceled)

49. A binaural technology method including
determining a first position related to a 3D position of left ear of a listener,
determining a second position related to a 3D position of right ear of the listener,
receiving a wireless RF signal including binaural audio data, and
presenting the binaural audio data to the listener.

50. Method according to claim 49, the method further includes determining the binaural audio data based on the sensed first and second positions prior to transmitting the wireless RF signal including the binaural audio data.

51. Method according to claim 49, wherein the first and second positions correspond to ear canal reference points for the binaural audio data.

52. Method according to claim 51, wherein the ear canal reference points are entrances to blocked ear canals of the listener.

53. Method according to claim 49, wherein the first and second positions are extracted from a second wireless RF signal.

54. Method according to claim 53, wherein the second wireless RF signal includes data indicating at least one of the first and second positions.

55. Method according to claim 53, wherein at least one of the first and second positions is extracted based on detecting a location from which the second wireless RF signal is transmitted.

56. Method according to claim 49, wherein the second wireless RF signal is transmitted from one of the first and second positions.

57. Method according to claim 56, wherein the second wireless RF signal is transmitted from a position in an ear canal of the listener.

58. Method according to claim 53, wherein the first and second positions are sensed in respective ears of the listener, and wherein data regarding the first and second positions are included in the second wireless RF signal.

59. Method according to claim 53, wherein the first position is extracted based on the second wireless RF signal, wherein the second position is extracted based on a third wireless RF signal, and wherein the first and second positions are extracted based on detecting locations from which the second and third wireless RF signals are transmitted.

60. Method according to claim 49, including the steps of recording binaural audio data in left and right ears of the listener.

61. Method according to claim 49, wherein a measure of interaural time delay is determined based on the first and second positions.

62. Method according to claim 49, wherein an estimate of orientation of the ears of the listener is at least partly based on the determined first and second positions.

63. Binaural technology system comprising
position tracking means arranged to determine first and second 3D positions related to positions of respective left and right ears of a listener,
an RF receiver arranged to receive a wireless RF signal including binaural audio data, and
a set of earphones arranged to generate sound pressures in the ears of the listener, the sound pressures representing the binaural audio data.

64. System according to claim 63, wherein the first and second positions correspond to ear canal reference points for the binaural data.

65. System according to claim 63, further including first and second microphones arranged for position at ear canal reference points for the binaural audio data.

66. System according to claim 65, wherein the first and second microphones are included in respective first and second earphone parts arranged for position in respective ears of the listener.

67. Use of the method according to claim 62 for one of: a binaural synthesis application, a binaural capturing application, an inverse binaural filtering application, a Virtual Reality application, a Mixed Reality application, a teleconferencing application, an inter-com application, an exhibition/museum application, and a traffic signal application.
